(19) United States
(12) Patent Application Publication
(10) Pub. No.: US 2026/0284791 A1
(43) Pub. Date: Sep. 24, 2026

(54) NOTCHING DEVICE FOR SECONDARY BATTERY

(71) Applicant: SK On Co., Ltd., Seoul (KR)

(72) Inventors: Oh San AN, Daejeon (KR); Ji Yoon YOUM, Daejeon (KR); Seul Gi LEE, Daejeon (KR); Deok Min JEON, Daejeon (KR); Min Jeong HONG, Daejeon (KR)

(21) Appl. No.: 19/565,531

(22) Filed: Mar. 13, 2026

(30) Foreign Application Priority Data
Mar. 18, 2025 (KR) 10-2025-0034474

(51) Int. Cl. B23K 26/364; B23K 26/03; B23K 26/035; B23K 26/08; B23K 101/38

(52) U.S. Cl. CPC B23K 26/364; B23K 26/032; B23K 26/035; B23K 26/0846; B23K 2101/38

(57) ABSTRACT

The present disclosure relates to a notching device which include: a transporter transporting an electrode along a first direction; an encoder outputting a first signal along the first direction based on movement of the transporter; a signal generator outputting a second signal along a second direction among directions perpendicular to the first direction; a laser notching the electrode; and a controller controlling the layer to calibrate a first position along the first direction of the laser to a first calibration position using the first signal, calibrate a second position along the second direction of the laser to a second calibration position using the second signal, and notch the electrode at the first calibration position and the second calibration position.

### CROSS-REFERENCE TO RELATED PATENT APPLICATION

The present application claims priority under 35 U.S.C. § 119(a) to Korean patent application number 10-2025-0034474 filed on Mar. 18, 2025, in the Ministry of Intellectual Property, the entire disclosure of which is incorporated by reference herein.

### BACKGROUND OF THE INVENTION

### 1. Field

The present disclosure relates to a notching device used in the manufacture of secondary batteries.

### 2. Description of the Related Art

A battery cell, which is typically a unit of secondary batteries, has a structure with an electrode assembly embedded within a battery cell exterior material, and includes a liquid electrolyte or a solid electrolyte. In this case, the electrode assembly may include electrodes and separators (or, an electrolyte layer in the case of a solid electrolyte).

The electrode assembly included in the battery cell may be manufactured in a size designed based on the size and shape of the battery cell exterior material, the application in which it is to be used, and the capacity required. Accordingly, the process of manufacturing the battery cell may include a process of transferring electrodes, a process of cutting the transferred electrodes, and the like.

### SUMMARY OF THE INVENTION

According to an aspect of the present disclosure, an object of the present disclosure is to improve the accuracy in a notching position of an electrode.

According to another aspect of the present disclosure, an object of the present disclosure is to improve manufacturing quality of an electrode.

According to another aspect of the present disclosure, an object of the present disclosure is to simplify a manufacturing process that improves notching quality of an electrode.

In another aspect of the disclosure, an object of the present disclosure is to calibrate a notching position of a laser based on a degree of meandering of an electrode.

The present disclosure may be widely applied in the field of electric vehicles, battery charging stations, and other green technologies that utilize batteries, such as solar and wind power generation. Furthermore, the present disclosure may be used for eco-friendly electric vehicles, hybrid vehicles, and the like to prevent climate change by curbing air pollution and greenhouse gas emission.

A notching device according to the present disclosure may include: a transporter transporting an electrode along a first direction; an encoder outputting a first signal along the first direction based on movement of the transporter; a signal generator outputting a second signal along a second direction among directions perpendicular to the first direction; a laser notching the electrode; and a controller controlling the layer to calibrate a first position along the first direction of the laser to a first calibration position using the first signal, calibrate a second position along the second direction of the laser to a second calibration position using the second signal, and notch the electrode at the first calibration position and the second calibration position.

The notching device according to the present disclosure may further include a camera acquiring images of the electrode.

According to an embodiment, the signal generator may output the second signal using a pixel value of the image.

According to an embodiment, the pixel value may represent a pixel value for a boundary of a coated portion of the electrode and an uncoated portion of the electrode.

According to an embodiment, the first signal may include a plurality of signals, wherein the plurality of signals may include a first pulse signal in an A phase and a second pulse signal in a B phase.

According to an embodiment, the second signal may include a plurality of signals, wherein the plurality of signals may include a third pulse signal in an A phase and a fourth pulse signal in a B phase.

According to an embodiment, the signal generator may compare a difference between an encoder value and the pixel value with a threshold value.

According to an embodiment, the signal generator may determine, based on comparing the difference with the threshold value, an output time for each of the third pulse signal and the fourth pulse signal.

According to an embodiment, the signal generator may output, when the difference is less than the threshold value, a low signal of the fourth pulse signal at the time of outputting a rising edge of the third pulse signal.

According to an embodiment, the signal generator may output, when the difference is less than the threshold value, a high signal of the fourth pulse signal at the time of outputting a falling edge of the third pulse signal.

According to an embodiment, the signal generator may output, when the difference is greater than the threshold value, a low signal of the third pulse signal at the time of outputting a rising edge of the fourth pulse signal.

According to an embodiment, the signal generator may output, when the difference is greater than the threshold value, a high signal of the third pulse signal at the time of outputting a falling edge of the fourth pulse signal.

According to an embodiment, the laser may include a plurality of lasers arranged along the first direction.

According to an embodiment, the controller may include a plurality of controllers controlling each of the plurality of lasers, and the notching device according to the present disclosure may further include a splitter providing the first signal and the second signal to each of the plurality of controllers.

According to an embodiment, the plurality of controllers may control each of the plurality of lasers to cause each of the plurality of lasers to notch the electrode at the first calibration position and the second calibration position.

According to an embodiment of the present disclosure, the accuracy in a notching position of an electrode may be improved.

According to another embodiment of the present disclosure, manufacturing quality of an electrode may be improved.

According to another embodiment of the present disclosure, notching quality of an electrode may be improved.

According to another embodiment of the present disclosure, a notching position of a laser may be calibrated according to a degree of meandering of an electrode.

### BRIEF DESCRIPTION OF THE DRAWINGS

FIG. 1 is a block diagram schematically illustrating a notching device according to the present disclosure.

FIG. 2 is a diagram illustrating a view in which an electrode is notched using a notching device according to the present disclosure.

FIG. 3 is a flowchart to illustrate a method of calibrating a first position of a laser to a first calibration position.

FIG. 4 is a flowchart to illustrate a method of calibrating a second position of a laser to a second calibration position.

FIG. 5 is a diagram illustrating a pulse signal in an A phase and a pulse signal in a B phase that increase an encoder value.

FIG. 6 is a diagram illustrating a pulse signal in an A phase and a pulse signal in a B phase that decrease an encoder value.

FIG. 7 is a flowchart to illustrate a method of calibrating a second position of a laser to a second calibration position.

### DETAILED DESCRIPTION

Specific terms used herein are for convenience of description only and are not intended to limit the embodiments shown.

For example, the expressions "identical" and "identical to" refer not only to strictly identical conditions, but also to conditions with tolerances or differences in the degree to which the same function is achieved.

For example, expressions such as "in any direction," "along any direction," "in parallel with," "perpendicular," "centered," "concentric," or "coaxial" that refer to a relative or absolute placement not only refer to such placement strictly, but also to a state of relative displacement by a tolerance, or by an angle or distance of deriving the same function.

The use of terms such as "first, second, third," and the like preceding the components referred herein is intended to avoid confusion regarding the components to which they refer, but not intended to indicate any order, importance, or dominant-subordinate relationship between the components. For example, an invention may also be implemented that includes only the second component without the first component.

As used herein, singular expressions include the plural unless the context clearly indicates otherwise.

In the following, the present disclosure will be described in detail with reference to the accompanying drawings. However, these are exemplary only and do not limit the present disclosure to the specific embodiments illustrated herein. Throughout the specification, identical reference numbers are used to denote identical components.

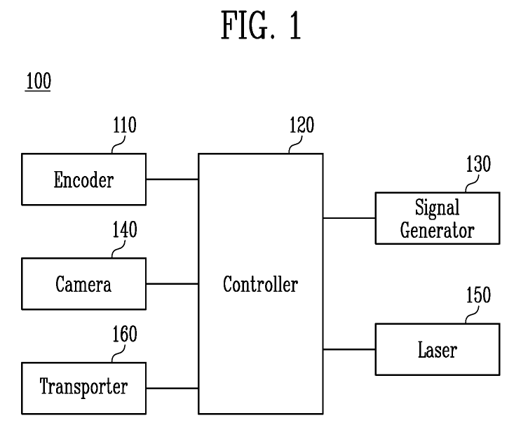

FIG. 1 is a block diagram schematically illustrating a notching device according to the present disclosure.

Referring to FIG. 1, according to an embodiment, a notching device 100 may include an encoder 110, a signal generator 130, a camera 140, a laser 150, a transporter 160, and a controller 120.

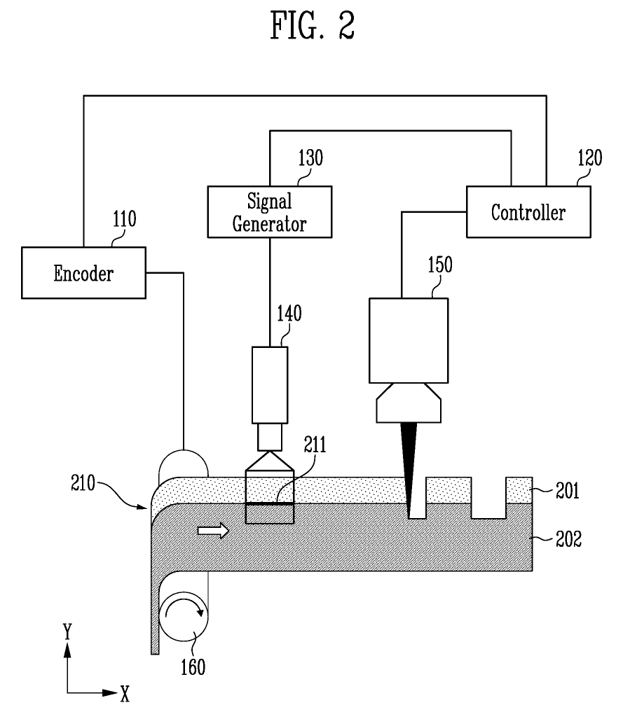

According to an embodiment, the notching device 100 may be a device to determine meander information of an electrode 210 (in FIG. 2), calibrate a position of the laser 150 based on the meander information of the electrode 210, and notch the electrode 210 at the calibrated position. According to an embodiment, the meander information may include information about an angle and/or distance that the electrode 210 deviates from a preset baseline. In this case, the position of the laser 150 may indicate a position along a predetermined first direction (X-axis direction) and a position along a second direction (Y-axis direction) among directions perpendicular to the first direction.

According to an embodiment, the laser 150 may include a light source outputting light and a scanner determining a path of the light. The scanner may include a galvanometer capable of adjusting the path of the light. According to an embodiment, the laser 150 may notch the electrode 210. According to an embodiment, the laser 150 may adjust the path of light output from the light source using a scanner based on the calibrated position. This allows the laser 150 to notch the electrode 210 at the calibrated position.

Hereinafter, a method of calibrating a position of a laser 150 along a first direction will be described.

According to an embodiment, the transporter 160 may transport the electrode 210 along a preset first direction (along the X-axis direction). According to an embodiment, the transporter 160 may continuously transport the electrode 210 for processing of the electrode 210. The transporter 160 may be a roller.

According to an embodiment, the encoder 110 may be connected to the transporter 160. According to an embodiment, the encoder 110 may output a first signal along a first direction (X-axis direction) based on the movement of the transporter 160. According to an embodiment, the first signal may be a signal for obtaining meander information of the electrode 210 along the first direction.

According to an embodiment, the first signal may be a plurality of signals. According to an embodiment, the first signal may include a first pulse signal in an A phase and a second pulse signal in a B phase. Each of the A phase and the B phase may represent an A phase that occurs in accordance with a rotation angle of the encoder 110 and a B phase of the encoder 110, respectively. For example, the first signal may refer to a signal corresponding to a distance traveled by the electrode 210 along a preset first direction (X-axis direction).

According to an embodiment, the first pulse signal may be a pulse wave with repeated high and low signals. According to an embodiment, the second pulse signal may be a pulse wave with repeated high and low signals. In this case, in an embodiment, the difference between the phase of the first pulse signal and the phase of the second pulse signal may be a preset difference. For example, the preset difference may be 90 degrees.

According to an embodiment, the controller 120 may use the first signal to calibrate a first position along the first direction of the laser 150 to a first calibration position. The first position may represent a preset position along the first direction of the laser 150 for notching the electrode 210. For example, a preset position along the first direction may refer to a current position along the first direction of the laser 150.

In the following, a method of calibrating a position along the second direction of the laser 150 will be described.

According to an embodiment, the second direction (Y-axis direction) may be any one of the directions perpendicular to the first direction (X-axis direction). In this case, the second direction may represent a direction in which the laser 150 faces the electrode 210.

According to an embodiment, the signal generator 130 may generate a second signal to calibrate the position of the laser 150 along the second direction. The signal generator 130 is not electrically or physically connected to an encoder, but may output an encoder signal. The encoder signal may be a pulse signal in the A phase and a pulse signal in the B phase. For example, the second signal may be a signal corresponding to a distance traveled by the electrode 210 along the second direction. According to an embodiment, the second signal may be a signal to obtain meander information of the electrode 210 along the second direction.

According to an embodiment, the signal generator 130 may be implemented as a processor. For example, the signal generator 130 may be implemented as a central processing unit (CPU). However, this is an example, and the devices that may be implemented as the signal generator 130 may not be limited.

According to an embodiment, the controller 120 may control the overall operation of the notching device 100. According to an embodiment, the controller 120 may be implemented as a printed circuit board (process control block). Alternatively, according to an embodiment, the controller 120 may be implemented as a processor. For example, the controller 120 may be implemented as a different processor than the signal generator 130, or it may be implemented as the same processor as the signal generator 130.

According to an embodiment, the camera 140 may acquire images of the electrodes 210.

According to an embodiment, the signal generator 130 may output a second signal along the second direction using pixel values of the image. According to an embodiment, the pixel value may refer to a pixel value for boundaries of an uncoated portion and a coated portion of the electrode 210. According to an embodiment, the uncoated portion may be a portion of the electrode 210 with no electrode active material applied, and the coated portion may be a portion of the electrode 210 with an electrode active material applied.

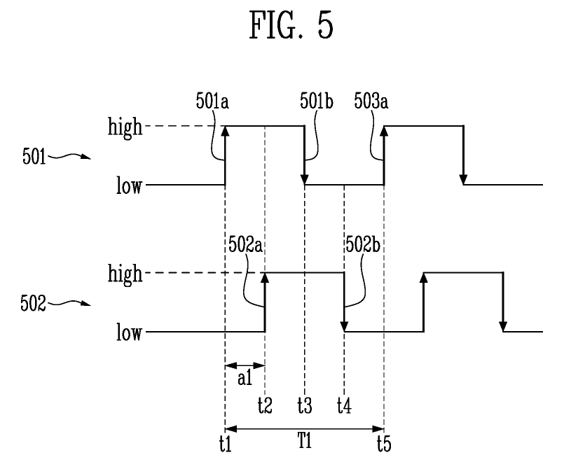

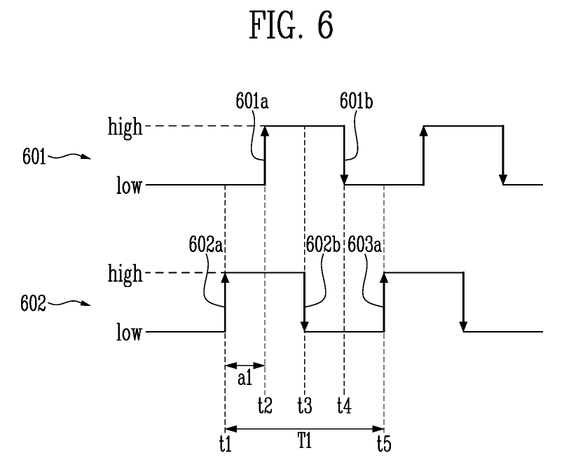

According to an embodiment, the signal generator 130 may output a second signal according to an encoder rule. The encoder rule may refer to a rule for increasing or decreasing an encoder value, depending on a relationship between the output time of a rising edge and a falling edge of the pulse signal in the A phase and the output time of a high signal and a low signal of the pulse signal in B phase. This will be described in detail with reference to FIGS. 5 and 6.

According to an embodiment, the second signal may be a plurality of signals. According to an embodiment, the second signal may include a third pulse signal in the A phase and a fourth pulse signal in the B phase.

According to an embodiment, the third pulse signal may refer to a pulse wave with repeated high and low signals. According to an embodiment, the fourth pulse signal may refer to a pulse wave with repeated high and low signals. In an embodiment, the phase difference between the phase of the third pulse signal and the phase of the fourth pulse signal may be a preset difference.

According to an embodiment, the controller 120 may use the second signal to calibrate a second position along the second direction of the laser 150 to a second calibration position. The second position may represent a preset position along the second direction of the laser 150 for notching the electrode 210. For example, the preset position along the second direction may refer to a current position along the second direction of the laser 150.

According to an embodiment, the controller 120 may control the laser 150 to notch the electrode 210 at the first calibration position and the second calibration position.

According to an embodiment, the laser 150 may adjust a path of light using a scanner to notch the electrode 210 at the first calibration position and the second calibration position. According to an embodiment, the laser 150 may notch the electrode 210 at the first calibration position and the second calibration position.

According to an embodiment, the laser 150 may include a plurality of lasers arranged along the first direction.

According to an embodiment, the controller 120 may include a plurality of controllers controlling each of the plurality of lasers.

According to an embodiment, the notching device 100 according to the present disclosure may further include a splitter providing the first signal and the second signal to each of the plurality of controllers.

According to an embodiment, the plurality of controllers may control each of the plurality of lasers to cause each of the plurality of lasers to notch the electrode at the first calibration position and the second calibration position.

FIG. 2 is a diagram illustrating a view in which an electrode is notched using a notching device according to the present disclosure.

Referring to FIG. 2, according to an embodiment, the electrode 210 may be transported along a first direction (x-axis direction) via a transporter 160. The transporter 160 may be a roller that transfers the electrode 210. According to an embodiment, the encoder 110 may be electrically coupled to the transporter 160. The encoder 110 may output a signal based on movement (e.g., rotation) of the transporter 160.

According to an embodiment, the electrode 210 may include an uncoated portion 201 with no electrode active material applied and a coated portion 202 with an electrode active material applied.

According to an embodiment, the camera 140 may photograph the electrode 210. More specifically, the camera 140 may photograph the boundary 211 between the uncoated portion 201 and the coated portion 202 of the electrode 210.

According to an embodiment, the signal generator 130 may be electrically coupled to the camera 140. According to an embodiment, the signal generator 130 may output a signal based on the image acquired by the camera 140.

According to an embodiment, the controller 120 may be electrically connected to the encoder 110, the signal generator 130, and the laser 150. According to an embodiment, the controller 120 may obtain a first calibration position along the first direction of the laser 150 and a second calibration position along the second direction of the laser 150.

According to an embodiment, the laser 150 may notch the electrode 210 at the first calibration position along the first direction and the second calibration position along the second direction.

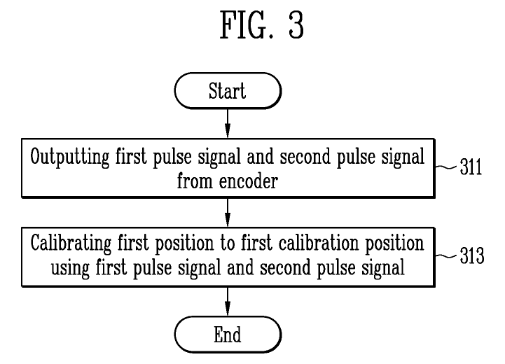

FIG. 3 is a flowchart to illustrate a method of calibrating a first position of the laser to a first calibration position.

Referring to FIG. 3, according to an embodiment, a method of notching an electrode using a notching device according to the present disclosure may include, in step 311, outputting a first pulse signal and a second pulse signal from the encoder 110.

According to an embodiment, the method of notching an electrode using a notching device according to the present disclosure may include outputting the first pulse signal and the second pulse signal in accordance with rotation of the encoder 110.

According to an embodiment, the first pulse signal may represent a pulse signal in an A phase. According to an embodiment, the second pulse signal may represent a pulse signal in a B phase. According to an embodiment, the first pulse signal may represent a pulse wave with repeated high and low signals. According to an embodiment, the second pulse signal may represent a pulse wave with repeated high and low signals. In this case, according to an embodiment, the difference between the phase of the first pulse signal and the phase of the second pulse signal may be a preset difference. For example, the preset difference may be 90 degrees.

The method of notching an electrode using a notching device according to the present disclosure may include, in step 313, calibrating a first position to a first calibration position using the first pulse signal and the second pulse signal.

The method of notching an electrode using a notching device according to the present disclosure may include controlling the laser 150 to notch the electrode 210 at the first calibration position.

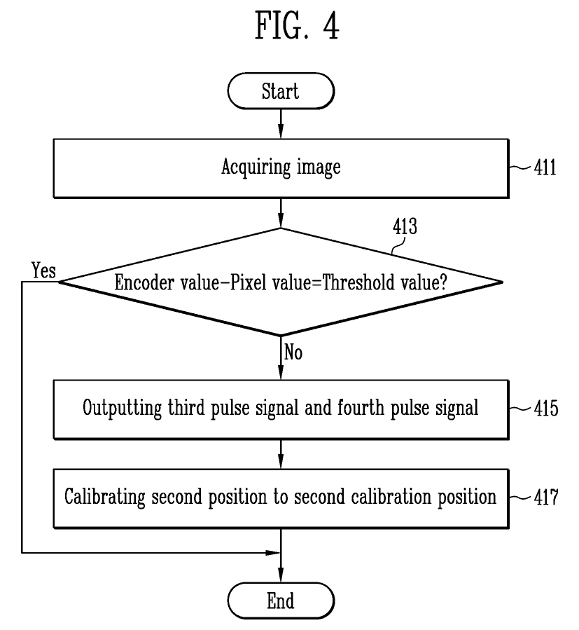

FIG. 4 is a flowchart to illustrate the method of calibrating a second position of the laser to a second calibration position.

Referring to FIG. 4, according to an embodiment, the method of notching an electrode using a notching device according to the present disclosure may include, in step 411, acquiring an image of the electrode 210 using the camera 140.

According to an embodiment, the method of notching an electrode using a notching device according to the present disclosure may include, in step 413, determining whether a difference between an encoder value and a pixel value of the image is equal to a threshold value.

According to an embodiment, the encoder value may represent a preset value. According to an embodiment, the pixel values of the image may represent pixel values for a boundary of an uncoated portion and a coated portion of the electrode 210 in the image.

According to an embodiment, the threshold value may represent a value that determines whether to calibrate the position of the laser 150 along the second direction. According to an embodiment, the threshold value may be set to zero, but this is an example and may be set to various values.

According to an embodiment, the method of notching an electrode using a notching device according to the present disclosure may include not calibrating the second position of the laser 150 along the second direction in the case that the difference between the encoder value and the pixel value of the image is equal to the threshold value (step 413-Yes). According to an embodiment, the method of notching an electrode using a notching device according to the present disclosure may include notching, by the laser 150, the electrode 210 at a second position. For example, the second position may refer to the current position along the second direction of the laser 150. In other words, when the difference between the encoder value and the pixel value of the image is equal to a threshold value, it may indicate that the electrode 210 is not meandered along the second direction.

According to an embodiment, the method of notching an electrode using a notching device according to the present disclosure may include, outputting, when the difference between the encoder value and the pixel value of the image is not equal to the threshold value (step 413-No), in step 415, a third pulse signal and a fourth pulse signal. The third pulse signal may be a pulse signal in the A phase, and the fourth pulse signal may be a pulse signal in the B phase.

According to an embodiment, the method of notching an electrode using a notching device according to the present disclosure may include, in step 417, based on the third pulse signal and the fourth pulse signal, calibrating a second position to a second calibration position.

In this case, the outputting the third pulse signal and the fourth pulse signal may include determining an output order and an output time of each of the third pulse signal and the fourth pulse signal to increase the encoder value or decrease the encoder value such that the difference between the encoder value and the pixel value of the image is equal to a threshold value.

First, when the difference between the encoder value and the pixel value of the image is less than the threshold value, the determining the output order and the output time of each of the third pulse signal and the fourth pulse signal to increase the encoder value so that the difference between the encoder value and the pixel value of the image is equal to the threshold value will be described with reference to FIG. 5.

FIG. 5 is a diagram illustrating a pulse signal in the A phase and a pulse signal in the B phase that increase an encoder value.

More specifically, FIG. 5 is a diagram illustrating a pulse signal 501 in an A phase over time and a pulse signal 502 in a B phase over time.

The pulse signal 501 in the A phase and the pulse signal 502 in the B phase may be a pulse wave that a high signal and a low signal are repeatedly output.

The pulse signal 501 in the A phase may output a rising edge 501a at a first time t1, ahead of the pulse signal 502 in the B phase by a specified time a1. The pulse signal 502 in the B phase may output the rising edge 502a at a second time t2, which is a specified time a1 after the first time t1.

The pulse signal 501 in the A phase may output a falling edge 501b at a third time t3. In this case, the pulse signal 502 in the B phase may be a high signal.

The pulse signal 502 in the B phase may output the falling edge 502b at the fourth time t4. In this case, the pulse signal 501 in the A phase may be a low signal.

The pulse signal 501 in the A phase and the pulse signal 502 in the B phase may be output every specified period T1. The specified period T1 may represent a time interval between a first time t1 and a fifth time t5.

The interval a1 between the first time t1 and the second time t2, the interval between the second time t2 and the third time t3, the interval between the third time t3 and the fourth time t4, and the interval between the fourth time t4 and the fifth time t5 may be equal to each other. For example, the interval a1 between the first time t1 and the second time t2 may be a time interval corresponding to a phase of 90 degrees.

At the first time t1, the encoder value may be increased by 1. In other words, at the first time t1, the pulse signal 501 in the A phase outputs a rising edge 501a, and the pulse signal 502 in the B phase outputs a low signal, such that the encoder value may be increased by 1.

At the third time t3, the encoder value may be increased by 1. In other words, at the third time t3, the pulse signal 501 in the A phase outputs the falling edge 501b and the pulse signal 502 in the B phase outputs the high signal, such that the encoder value may be increased by 1.

At the fifth time t5, the encoder value may be increased by 1. In other words, at the fifth time t5, the pulse signal 501 in the A phase outputs the rising edge 503a and the pulse signal 502 in the B phase outputs the low signal, such that the encoder value may be increased by 1.

In other words, when the pulse signal 501 in the A phase outputs a rising edge and the pulse signal 502 in the B phase outputs a low signal, the encoder value may be increased. When the pulse signal 501 in the A phase outputs a falling edge and the pulse signal 502 in the B phase outputs a high signal, the encoder value may be increased.

As illustrated in FIG. 5, the method of notching an electrode using a notching device according to the present disclosure may include determining an output order of each of the third pulse signal and the fourth pulse signal using a rule for increasing the encoder value.

According to an embodiment, the method of notching an electrode using a notching device according to the present disclosure may include determining, when the difference between the encoder value and the pixel value of the image is less than a threshold value, to output the third pulse signal ahead of the fourth pulse signal by a preset phase. The preset phase may represent 90 degrees. The preset phase may be an angle corresponding to a1.

According to an embodiment, the method of notching an electrode using a notching device according to the present disclosure may include determining, when a difference between an encoder value and a pixel value of an image is less than a threshold value, the output time and output counts of a rising edge and a falling edge of a third pulse signal, and the output time and output counts of a high signal and a low signal of a fourth pulse signal.

According to an embodiment, the notching device 100 may store a lookup table for the output times and output counts of the rising edge and falling edge of the third pulse signal and the output times and output counts of the high signal and low signal of the fourth pulse signal that cause the difference and the threshold value to be equal. According to an embodiment, the method of notching an electrode using a notching device according to the present disclosure may enable determination of the third pulse signal and the fourth pulse signal using the lookup table.

When the difference between the encoder value and the pixel value of the image is greater than a threshold value, the determining an output order and an output time for each of the third pulse signal and the fourth pulse signal to decrease the encoder value so that the difference between the encoder value and the pixel value of the image is equal to the threshold value will be described with reference to FIG. 6.

FIG. 6 is a diagram illustrating a pulse signal in the A phase and a pulse signal in the B phase to decrease an encoder value.

More specifically, FIG. 6 is a diagram illustrating a pulse signal 601 of an A phase over time and a pulse signal 602 of a B phase over time.

The pulse signal 601 in the A phase and the pulse signal 602 in the B phase may be a pulse wave in which a high signal and a low signal are repeatedly output.

The pulse signal 602 in the B phase may output a rising edge 602a at a first time t1 ahead of the pulse signal 601 in the A phase by a specified time a1. The pulse signal 601 in the A phase may output the rising edge 601a at a second time t2, which is after the specified time a1 from the first time t1.

The pulse signal 602 in the B phase may output a falling edge 602b at a third time t3. In this case, the pulse signal 601 in the A phase may be a high signal.

The pulse signal 601 in the A phase may output the falling edge 601b at the fourth time t4. In this case, the pulse signal 602 in the B phase may be a low signal.

The pulse signal 601 in the A phase and the pulse signal 602 in the B phase may be output every specified period T1. The specified period T1 may represent a time interval between a first time t1 and a fifth time t5.

The interval a1 between the first time t1 and the second time t2, the interval between the second time t2 and the third time t3, the interval between the third time t3 and the fourth time t4, and the interval between the fourth time t4 and the fifth time t5 may be equal to each other. For example, the interval a1 between the first time t1 and the second time t2 may be a time interval corresponding to a phase of 90 degrees.

At the first time t1, the encoder value may decrease by 1. In other words, at the first time t1, the pulse signal 602 in the B phase outputs a rising edge 602a, and the pulse signal 601 in the A phase outputs a low signal, such that the encoder value may decrease by 1.

At the third time t3, the encoder value may decrease by 1. In other words, at the third time t3, the pulse signal 602 in the B phase outputs the falling edge 602b and the pulse signal 601 in the A phase outputs the high signal, such that the encoder value may decrease by 1.

At the fifth time t5, the encoder value may decrease by 1. In other words, at the fifth time t5, the pulse signal 602 in the B phase outputs the rising edge 603a and the pulse signal 601 in the A phase outputs the low signal, such that the encoder value may decrease by 1.

In other words, when the pulse signal 602 in the B phase outputs a rising edge and the pulse signal 601 in the A phase outputs a low signal, the encoder value may decrease. When the pulse signal 602 in the B phase outputs a falling edge and the pulse signal 601 in the A phase outputs a high signal, the encoder value may decrease.

As described in FIG. 6, under the rule for decreasing the encoder value, the method of notching an electrode using a notching device according to the present disclosure may include determining an output order for each of the third pulse signal and the fourth pulse signal.

According to an embodiment, the method of notching an electrode using a notching device according to the present disclosure may include determining, when the difference between the encoder value and the pixel value of the image is greater than a threshold value, to output the third pulse signal later than the fourth pulse signal by a predetermined phase. The preset phase may represent 90 degrees. The preset phase may be an angle corresponding to a1.

According to an embodiment, the method of notching an electrode using a notching device according to the present disclosure may include determining, when a difference between an encoder value and a pixel value of an image is greater than a threshold value, the output time and output counts of a rising edge and a falling edge of a third pulse signal, and the output time and output counts of a high signal and a low signal of a fourth pulse signal.

According to an embodiment, the notching device 100 may store a lookup table of the output times and output counts of the rising edge (or high signal) and the falling edge (or low signal) of the third pulse signal, and the output times and output counts of the high signal and the low signal of the fourth pulse signal that cause the difference and the threshold value to be equal. According to an embodiment, in the method of notching an electrode using a notching device according to the present disclosure, using the lookup table, the third pulse signal and the fourth pulse signal may be determined.

According to an embodiment, the method of notching an electrode using a notching device according to the present disclosure may include, in step 419, calibrating the second position to a second calibration position using the third pulse signal and the fourth pulse signal.

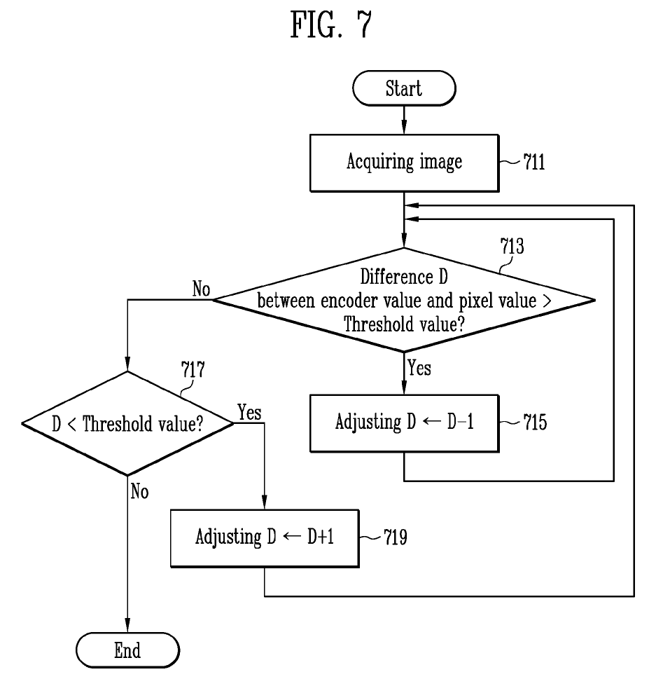

FIG. 7 is a flowchart to illustrate a method of calibrating a second position of a laser to a second calibration position.

Comparing FIGS. 4 and 7, in FIG. 4, the third pulse signal and the fourth pulse signal stored in the lookup table may be acquired at once such that the difference between the encoder value and the pixel value of the image is equal to a threshold value.

In FIG. 7, whether the difference between the encoder value and the pixel value is equal to the threshold value is checked every preset time, and thereby the pulse waves to increase or decrease the encoder value that are acquired every preset time may be obtained as a whole as the third pulse signal and the fourth pulse signal, respectively.

Referring to FIG. 7, according to an embodiment, the method of notching an electrode using a notching device according to the present disclosure may include, in step 711, acquiring an image of the electrode 210 using the camera 140.

According to an embodiment, the method of notching an electrode using a notching device according to the present disclosure may include, in step 713, determining whether a difference D between an encoder value and a pixel value of the image is greater than a threshold value.

According to an embodiment, the method of notching an electrode using a notching device according to the present disclosure may include, when the difference D is determined to be greater than the threshold value (step 713-Yes), in step 715, adjusting D-1 to the difference D. In other words, in step 715, a rule for decreasing the encoder value may be applied so that D-1 may be adjusted to the difference D. In other words, according to an embodiment, the method of notching an electrode using a notching device according to the present disclosure may include, in step 715, decreasing the encoder value by 1.

According to an embodiment, in the method of notching an electrode using a notching device according to the present disclosure, the method of notching an electrode using a notching device may further include, when the difference D is determined to be greater than a threshold value, determining whether the pulse signal in the B phase is a high signal, prior to the adjusting D-1 to the difference D. According to an embodiment, the method of notching an electrode using a notching device according to the present disclosure may, when the pulse signal in the B phase is a high signal, output a high signal (rising edge) as a pulse signal in the A phase and subsequently output a low signal as a pulse signal in the B phase. According to an embodiment, the method of notching an electrode using a notching device according to the present disclosure may, when the pulse signal in the B phase is a low signal, output a low signal (falling edge) as a pulse signal in the A phase and subsequently output a high signal as a pulse signal in the B phase.

According to an embodiment, in the method of notching an electrode using a notching device according to the present disclosure, when it is determined that the difference D is not greater than a threshold value (step 713-No), in step 717, whether the difference D is less than the threshold value may be determined.

According to an embodiment, the method of notching an electrode using a notching device according to the present disclosure may include, when the difference D is determined to be less than the threshold value (step 717-Yes), in step 719, adjusting D+1 to the difference D. In other words, in step 719, a rule for increasing the encoder value may be applied so that the D+1 may be adjusted to the difference D. In other words, according to an embodiment, the method of notching an electrode using a notching device according to the present disclosure may include, in step 719, increasing the encoder value by 1.

According to an embodiment, in the method of notching an electrode using a notching device according to the present disclosure, the method of notching an electrode using a notching device may, when the difference D is determined to be less than a threshold value, further include determining whether the pulse signal in the B phase is a high signal, prior to the adjusting D+1 to the difference D. According to an embodiment, in the method of notching an electrode using a notching device according to the present disclosure, when the pulse signal in the B phase is a high signal, a low signal (falling edge) may be output as a pulse signal in the A phase and then a high signal may continue to be output as a pulse signal in the B phase. According to an embodiment, in the method of notching an electrode using the notching device according to the present disclosure, when the pulse signal in the B phase is a low signal, a high signal (rising edge) may be output as a pulse signal in the A phase and then a low signal may continue to be output as a pulse signal in the B phase.

Steps 713, 715, 717, and/or 719 may be performed repeatedly until the adjusted value of the difference D between the encoder value and the pixel value is equal to the threshold value. In other words, according to an embodiment, in the method of notching the electrode using the notching device according to the present disclosure, when the difference D is determined not to be less than the threshold value (step 717-No), the adjusting the difference D between the encoder value and the pixel value may be terminated.

Until the adjusted value of the difference D between the encoder value and the pixel value becomes equal to the threshold value, the final pulse signal in the A phase and pulse signal in the B phase obtained as a result of repeating steps 713, 715, 717, and/or 719 may be obtained as the third pulse signal and the fourth pulse signal, respectively.

The present disclosure may be practiced in various modifications, and the scope of the disclosure is not limited to the embodiments described above. The above description is merely an example of application of the principles of the present disclosure, and other configurations may further be included without departing from the scope of the present disclosure. Therefore, when a modified embodiment includes components of the patent claims of the present disclosure, it should be considered to fall within the scope of the present disclosure.

What is claimed is:

1. A notching device comprising:
a transporter transporting an electrode along a first direction;
an encoder outputting a first signal along the first direction based on movement of the transporter;
a signal generator outputting a second signal along a second direction among directions perpendicular to the first direction;
a laser notching the electrode; and
a controller controlling the layer to calibrate a first position along the first direction of the laser to a first calibration position using the first signal, calibrate a second position along the second direction of the laser to a second calibration position using the second signal, and notch the electrode at the first calibration position and the second calibration position.

2. The notching device according to claim 1, further comprising a camera acquiring images of the electrode.

3. The notching device according to claim 2, wherein the signal generator outputs the second signal using a pixel value of the image.

4. The notching device according to claim 3, wherein the pixel value represents a pixel value for a boundary of a coated portion of the electrode and an uncoated portion of the electrode.

5. The notching device according to claim 1, wherein the first signal includes a plurality of signals,
wherein the plurality of signals include a first pulse signal in an A phase and a second pulse signal in a B phase.

6. The notching device according to claim 3, wherein the second signal includes a plurality of signals,
wherein the plurality of signals include a third pulse signal in an A phase and a fourth pulse signal in a B phase.

7. The notching device according to claim 6, wherein the signal generator compares a difference between an encoder value and the pixel value with a threshold value.

8. The notching device according to claim 7, wherein the signal generator determines, based on comparing the difference with the threshold value, an output time for each of the third pulse signal and the fourth pulse signal.

9. The notching device according to claim 8, wherein the signal generator outputs, when the difference is less than the threshold value, a low signal of the fourth pulse signal at the time of outputting a rising edge of the third pulse signal.

10. The notching device according to claim 8, wherein the signal generator outputs, when the difference is less than the threshold value, a high signal of the fourth pulse signal at the time of outputting a falling edge of the third pulse signal.

11. The notching device according to claim 8, wherein the signal generator outputs, when the difference is greater than the threshold value, a low signal of the third pulse signal at the time of outputting a rising edge of the fourth pulse signal.

12. The notching device according to claim 8, wherein the signal generator outputs, when the difference is greater than the threshold value, a high signal of the third pulse signal at the time of outputting a falling edge of the fourth pulse signal.

13. The notching device according to claim 1, wherein the laser includes a plurality of lasers arranged along the first direction.

14. The notching device according to claim 13, wherein the controller includes a plurality of controllers controlling each of the plurality of lasers,
wherein the notching device further includes a splitter providing the first signal and the second signal to each of the plurality of controllers.

15. The notching device according to claim 14, wherein the plurality of controllers control each of the plurality of lasers to cause each of the plurality of lasers to notch the electrode at the first calibration position and the second calibration position.
